(19) United States
(12) Patent Application Publication
(10) Pub. No.: US 2024/0230458 A9
(43) Pub. Date: Jul. 11, 2024

(54) AI METHOD AND APPARATUS FOR DETECTION OF REAL-TIME DAMAGE USING AE (ACOUSTIC EMISSIONS)

(71) Applicant: UNIVERSITY OF SOUTH CAROLINA, COLUMBIA, SC (US)

(72) Inventors: PAUL ZIEHL, IRMO, SC (US); CASEY A. COLE, LAURENS, SC (US)

(21) Appl. No.: 18/304,457

(22) Filed: Apr. 21, 2023

Related U.S. Application Data
(60) Provisional application No. 63/355,401, filed on Jun. 24, 2022.

(51) Int. Cl. G01M 7/02; G06N 3/0464

(52) U.S. Cl. CPC G01M 7/025; G06N 3/0464

(57) ABSTRACT

Method and apparatus detect structural damage of structures using Acoustic Emission (AE) sensors. Using our method, structures can be monitored in real-time to predict damage level. This damage level assessment can be used to plan repairs and restorations of structures. Application can be used with concrete, and also applied to other materials such as composites. Predictive AE models may be tuned for determining structural damage zones, with the method extendable into any number of zones. An algorithm may be used in conjunction with decision tree filtering to use AE to predict structural damage zones, with the system able to perform analysis in real-time.

### PRIORITY CLAIM

The present application claims the benefit of priority of U.S. Provisional Patent Application No. 63/355,401, titled AI Method and Apparatus for Detection of Real-Time Damage Using AE (Acoustic Emissions), filed Jun. 24, 2022, and which is fully incorporated herein by reference for all purposes.

### STATEMENT REGARDING FEDERALLY SPONSORED RESEARCH OR DEVELOPMENT

This invention was made with government support under FA8650-19-C-5035, awarded by AFMCLO/JAZ. The government has certain rights in the invention.

### BACKGROUND OF THE PRESENTLY DISCLOSED SUBJECT MATTER

The presently disclosed subject matter deals with a system and method for characterizing the damage level in structural systems from Acoustic Emission (AE) data.

AE technology has been used for damage detection and source localization of fatigue crack growth in metallic structures. AE is well established as a nondestructive evaluation for monitoring the structural health by listening to the associated sound energy released by activities in a monitored structure.

The growing number of aging engineering structures and the variable working conditions generate the need for technology for health monitoring purposes. Acoustic emission (AE) is a known SHM and non-destructive testing (NDT) technique. The AE analysis method has been used for passive sensing of acoustic signals during a damaging process. The damage process can be impact damage, fatigue crack growth, plastic deformation, etc. in metallic or other structures, where fatigue crack growth is a common problem. The severity of the occurrence of fatigue crack growth increases with the aging of the structures. Since AE hit rates accelerate only when failure is imminent, current AE practice does not typically provide an early warning capability. An early warning capability, if existed, would greatly assist the effective management of structural fatigue in coordination with mission profile allocation and maintenance schedule.

Various analytic techniques have been previously developed to classify structural damage levels, using large amounts of historical data (300+ days) and number of sensors (10+) to produce accurate results. However, in the case of concrete structures, composite material structures, and combinations of concrete and composite materials, there are a few unique challenges which render such previous methods inoperable. For one, data can only be collected for a short period of time (for example 10 to 14 days). Therefore, large amounts of historical data cannot be collected. Secondly, data must be collected in a unique field setting that may only yield useable data on few sensors (perhaps only 1 or 2). The present disclosure addresses such shortcomings by outlining an analysis pipeline that tackles such two unique challenges to classify AE data into structural damage zones.

### SUMMARY OF THE PRESENTLY DISCLOSED SUBJECT MATTER

The presently disclosed subject matter deals with a system and method for characterizing the damage level in structural systems from Acoustic Emission (AE) data.

In some instances, presently disclosed subject matter relates to collection of acoustic emission (AE) data during an alkali silica reaction (ASR) process and correlating the received data to structural damage levels. In some such embodiments, potential measures of damage levels may include volumetric expansion and characteristic crack widths.

This presently disclosed subject matter entails, for example, in some embodiments three aspects:
1) Raw data is collected;
2) Collected raw data is fed to a series of rules (derived from a decision tree); and
3) Artificial intelligence (AI)-enabled prediction of damage zones is produced from the decision-tree filtered AE signals.

Method and apparatus characterize the damage level in structural systems resulting in the production of predictions in real-time for determined damage zones in a monitored structure.

We have developed a method of detecting structural damage of structures using specialized sensors. Using our method, structures can be monitored in real-time to predict damage level. This damage level assessment can be used to plan repairs and restorations of structures.

Machine-learning AI-enabled techniques may be used to sift through large AE signal datasets to predict zone damage levels in real-time.

It is to be understood that the presently disclosed subject matter equally relates to associated and/or corresponding methodologies. One exemplary such method relates to a computer-implemented method, comprising obtaining, by a computing system comprising one or more computing devices, detected Acoustic Emission (AE) data from sensors used with an associated structure to be monitored; inputting, by the computing system, the detected AE data into a machine-learned neural network architecture model configured to receive AE data sensed from a structure and to predictively model Structural Health Maintenance (SHM) of the structure and to determine at least two respective different damage zones associated with the monitored structure using decision tree-based rules; and receiving, by the computing system, as an output of the machine-learned neural network architecture model, a determination by the computing system of damage zone level predictions for the determined respective different damage zones of the associated monitored structure.

Other example aspects of the present disclosure are directed to systems, apparatus, tangible, non-transitory computer-readable media, user interfaces, memory devices, and electronic devices for high-frequency AE processing. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a computing system, comprising one or more processors; and one or more non-transitory computer-readable media that collectively store: a machine-learned Artificial Intelligence (AI)-enabled technology neural network architecture model configured to receive Acoustic Emission (AE) data sensed from a structure and to predictively model Structural Health Maintenance (SHM) of the structure; and instructions that, when executed by the one or more processors, configure the computing system to perform operations. Such operations in this exemplary embodiment may preferably comprise obtaining detected AE data from sensors used with an associated structure to be monitored; inputting the AE data into the machine-learned neural network architecture model; determining at least two respective different damage zones associated with the monitored structure using decision tree-based rules; and as an output of the machine-learned neural network architecture model, determining damage zone level predictions for the determined respective different damage zones of the associated monitored structure.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects, and advantages of various embodiments will become better understood with reference to the following description and appended claims. The accompanying figures, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates the architecture of a representative convolutional neural network (CNN) as may be used in some exemplary embodiments herewith;

FIGS. 2(a) and 2(b) diagrammatically illustrate concrete specimen and reinforcement details, respectively, of a presently disclosed exemplary test specimen;

FIG. 3 illustrates a diagram of an exemplary embodiment of a decision tree, relating to technology which may be practiced in accordance with the presently disclosed subject matter;

FIG. 4 illustrates a table of features derived from raw AE (Acoustic Emissions) data of a present example, along with units and ranges;

FIG. 5 represents presently disclosed classification of real-time AE data in to four structural damage zones, overlayed on exemplary volumetric expansion data;

FIG. 6(a) represents a graphical representation of a finalized decision tree per presently disclosed subject matter, highlighting an example of a leaf node used to determine the presence of significant damage (zone 4) within 94% accuracy based on AE data recorded on an exemplary concrete structure; and

FIG. 6(b) represents in tabular form an example set of rules for a class 4 leaf node.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

The following description and other modifications and variations to the presently disclosed subject matter may be practiced by those of ordinary skill in the art, without departing from the spirit and scope of the presently disclosed subject matter. In addition, it should be understood that aspects of the various embodiments may be interchanged either in whole or in part. Furthermore, those of ordinary skill in the art will appreciate that the following description is by way of example only and is not intended to limit the presently disclosed subject matter.

This presently disclosed subject matter entails, for example, three aspects:
1) Raw data is collected;
2) Collected raw data is fed to a series of rules (derived from a decision tree); and
3) Artificial intelligence (AI)-enabled prediction of damage zones is produced from the decision-tree filtered AE signals.

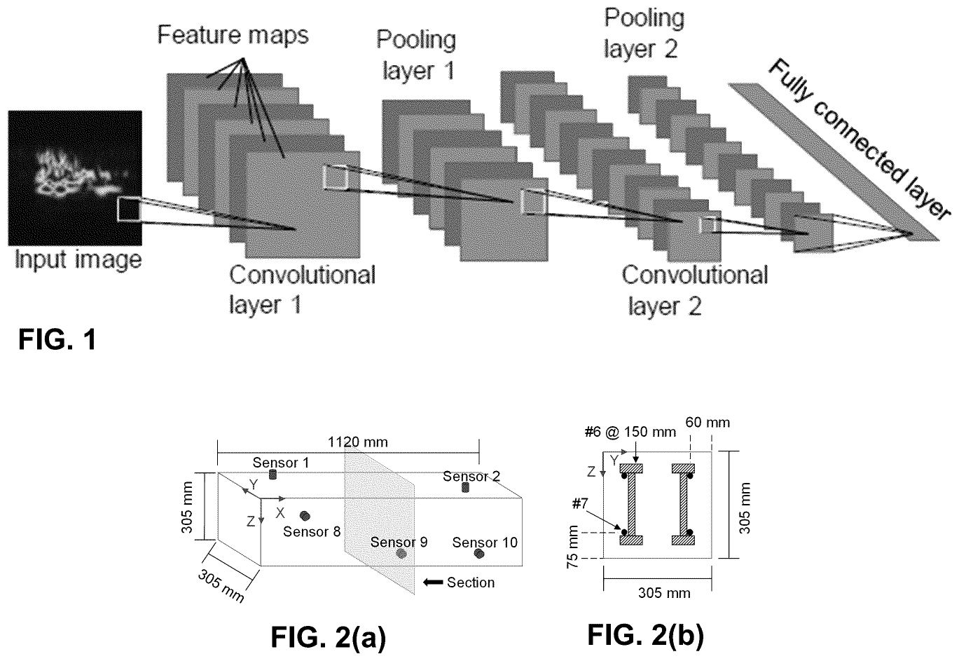

FIG. 1 illustrates the architecture of a representative convolutional neural network (CNN) as may be used in some exemplary embodiments herewith. Convolutional neural network technology (CNN) is a deep neural network with convolutional filters. CNN is generally composed of three main parts: an input layer, feature extraction layers and a fully connected layer. The core part of the feature extraction layers mainly includes convolutional layers and pooling layers. The architecture of a typical CNN with two convolutional layers and two pooling layers is shown in FIG. 1 herewith.

In the convolutional layer thereof, multiple convolutional kernels are employed to filter the input and generate feature maps. The pooling layer is used for down-sampling of feature maps obtained from the previous convolutional layer per known technology. If the image feature maps are directly used for classification without any processing, a great computational complexity will be generated, and the model is prone to overfitting. Therefore, a further reduction in the dimensionality of feature maps is desired, which is an advantage to construct the pooling layer after each convolutional layer. The fully connected layer is employed at the end of the CNN model. It converts the feature maps, resulting from the previous pooling layer, to one feature vector. An exemplary CNN model which may be applied is GoogLeNet, which was developed based on the prior LeNet model. The number of layers may in some instances be extended up to a relatively higher number. The GoogLeNet model in some instances may be pre-trained by a relatively large number of images from a subset of images (in some instances, such as the preexisting ImageNet database). In some instances, the input data may be 2D wavelet images. Before input datasets, data in some instances may be labeled and normalized, and the wavelet coefficients scaled (for example, such as between 0 and 1).

We have developed an algorithm that uses acoustic emission (AE) data from sensors to characterize the damage level in structural systems. This can then be hypothetically used to continuously monitor a structure and provide a prediction as to whether that structure has a certain level of damage. Our example system uses 4 structural damage zones, but our method is easily extendable into any number of zones. The core of the algorithm is a decision tree with a set of unique decision rules. Apart from potentially being the first algorithm to use AE to predict structural damage zones, the other novel component is that the system performs this analysis in real-time. Other methods rely on historical data (meaning they will need to collect multiple days, weeks, or months of data before they can determine the amount of damage). In that sense, this final product is very straightforward: Raw data is collected, fed to a series of rules (derived from a decision tree), and then a prediction (damage zones) is produced.

We have developed a method of detecting structural damage of structures using specialized sensors. Using our method, structures can be monitored in real-time to predict damage level. This damage level assessment can be used to plan repairs and restorations of structures.

Real-time structural damage evaluation can be used in a variety of applications. In this application of the method, we show its usage in evaluating concrete structures. This application can primarily be used by organizations such as the Department of Transportation to monitor bridges and other structures to access current damage levels to aid in restoration and repair planning. Although in this application we show its usage with concrete, it can also be applied to other materials such as composites.

Collecting data from AE sensors is nonintrusive and can be set up for remote sensing, meaning the structure being tested will not be damaged further and there is little human intervention needed to maintain a live system of AE sensing. The fact that it is real-time eliminates the need for collection of historical data (over the course of days, weeks or months) to make an assessment.

In some presently disclosed embodiments, classification of AE data into structural damage zones may be made using decision trees. In recent years, Acoustic Emission (AE) data has shown great promise in its use for passive, nondestructive monitoring of structures. Methods for utilizing this data to classify the current structural damage of the monitored structures have also flourished. However, structures equipped with AE sensors can produce vast amounts of large, and often, noisy data. Therefore, often a preprocessing or filtering step is performed on the data before utilizing it in such methods. These preprocessing steps are usually quite manual and subjective, requiring constant human intervention and often resulting in an overall process that is not easily reproducible or translatable to other systems.

Advanced data science techniques such as decision trees hold the promise to remove this preprocessing step entirely and operate solely on raw AE sensor data. Deep training of these methods result in models that are robust to excess noise within the raw data. In this work we show how decision tree analysis can be used to accurately predict a system's structural damage zone from raw AE data.

The primary dataset used to produce the analytic models in the presently disclosed pipeline was surrogate data obtained from a Department of Energy Nuclear Energy University Program research project. This surrogate sample was chosen due to completeness and high quality of data as well as the likelihood of similarity to the actual structure. In addition, data from other test specimens were used to cross-validate the models.

Test Setup for Surrogate Data

A reinforced concrete block specimen having dimensions of 305 mm×305 mm×1120 mm was fabricated and prepared for alkali silica reaction (ASR) testing. The specimen was cast with reactive coarse aggregates and was reinforced with steel rebars. The geometry of the specimen is shown in FIG. 2(a), with the details of the reinforcement shown in FIG. 2(b). The specimen had four longitudinal US #7 steel reinforcing bars and US #6 steel reinforcing bars with 150 mm spacing as transverse reinforcement. All reinforcing bars were T-headed to compensate for the short development length.

Ten AE sensors were attached on the surfaces of the specimen using double/bubble epoxy. The sensor layout is presented in FIG. 2(a). All sensors were PKWDI (Wideband Low Power Integral Preamplifier Resonant Sensors) with an operating frequency of 200-850 kHz.

A chamber (simulated storage chamber) with dimensions of 243 cm (width)×243 cm (length)×122 cm (height) was designed and built to accelerate the ASR process by providing high temperature and humidity. The temperature inside the chamber was kept at 37±3° C. and humidity was kept around 95%±5%. Demountable mechanical strain gauges (DEMEC) were used for expansion measurements in all three dimensions. Expansion was measured regularly every month. The test chamber was shut down for a period of approximately one month for modifications to the chamber itself.

Analysis Procedure

The analysis pipeline described below uses two major data analytic techniques: k-means cluster analysis and classification using decision trees. Each of the following sections describes these techniques in more detail as well as an overview of the full analysis pipeline.

K-Means Clustering

K-means clustering is an unsupervised learning technique that has been shown to be effective in a variety of applications. This algorithm attempts to optimally split the data into a certain number of clusters based on a given set of features. In this application, the number of clusters was defined as the number of desired structural zones. In an unsupervised learning technique such as k-means clustering, one major challenge is to determine if the clusters are a meaningful division of the feature space. Meaningfulness of clusters is determined by how well the cluster boundaries correlate with known boundaries in a given application field. In this application, the volumetric expansion as well as crack width data were used to determine meaningfulness.

Decision Trees

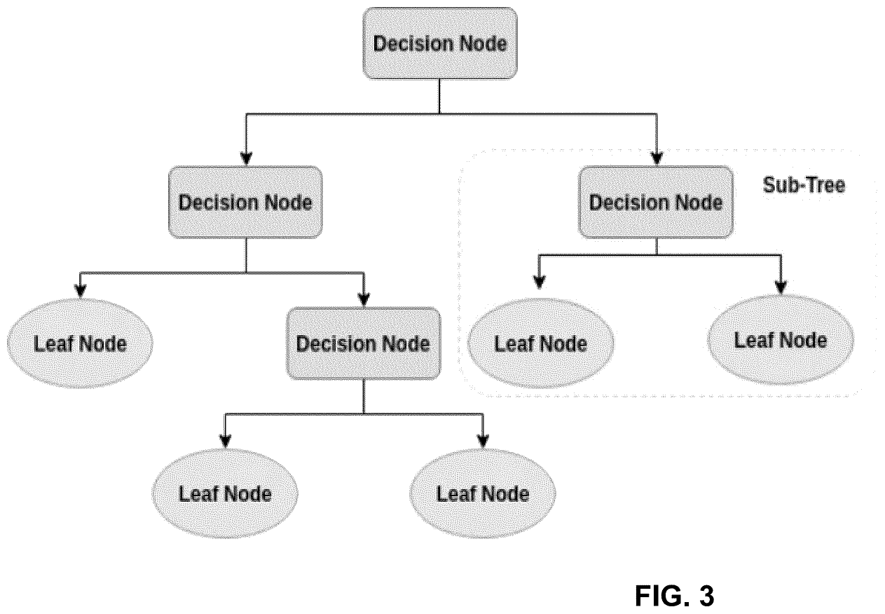

Decision tree analysis is a highly effect means of performing classification of data sets with multiple outcome classes. In general, this algorithm works by determining easy to interpret rules that iteratively split the feature space. The resulting set of rules determine a final decision tree that can then be used to classify future data points. A basic example of tree structure is shown in FIG. 3. Each “Decision Node” in general FIG. 3 represents a given rule (for example, If signal strength>10, traverse left hand side sub-tree, otherwise traverse right hand side sub-tree). Each “Leaf Node” represents a final decision. In this application the “Leaf Node” would represent a given structural damage zone.

Overview of Pipeline

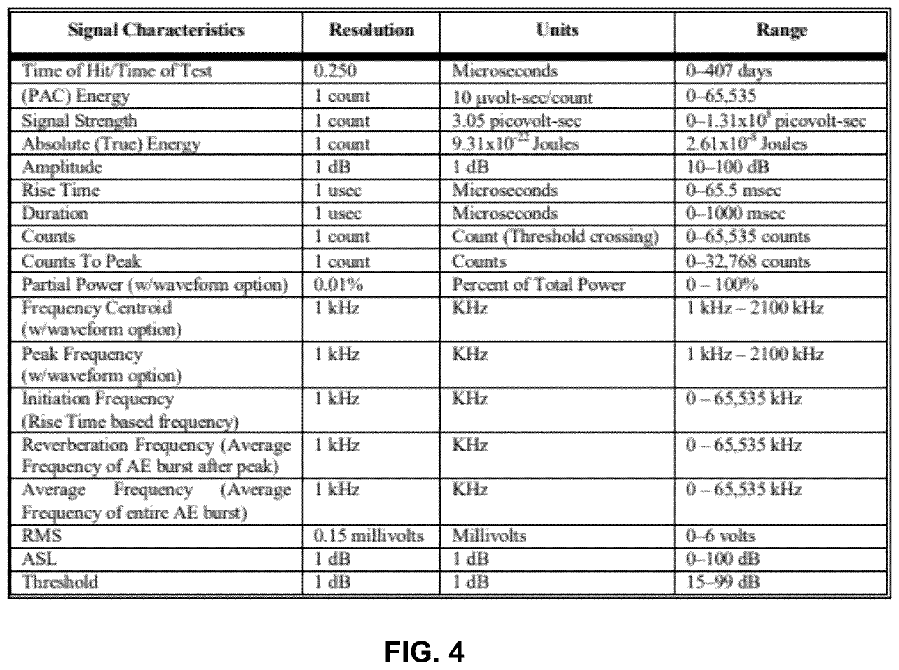

The general analysis pipeline consists of the following, whereby raw AE data was converted into the following features as listed in the Table of FIG. 4. In other words, the Table of FIG. 4 lists features derived from raw AE data along with units and ranges.

(1) Anomalous signals were filtered out using set thresholds (ex. all high energy (>=600), short duration (<=50)). These thresholds were determined by subject matter expert knowledge.

(2) Features were then clustered using the k-means algorithm into 4 structural damage zones (1—no damage, 2—minor damage, 3—moderate damage, 4— severe damage).

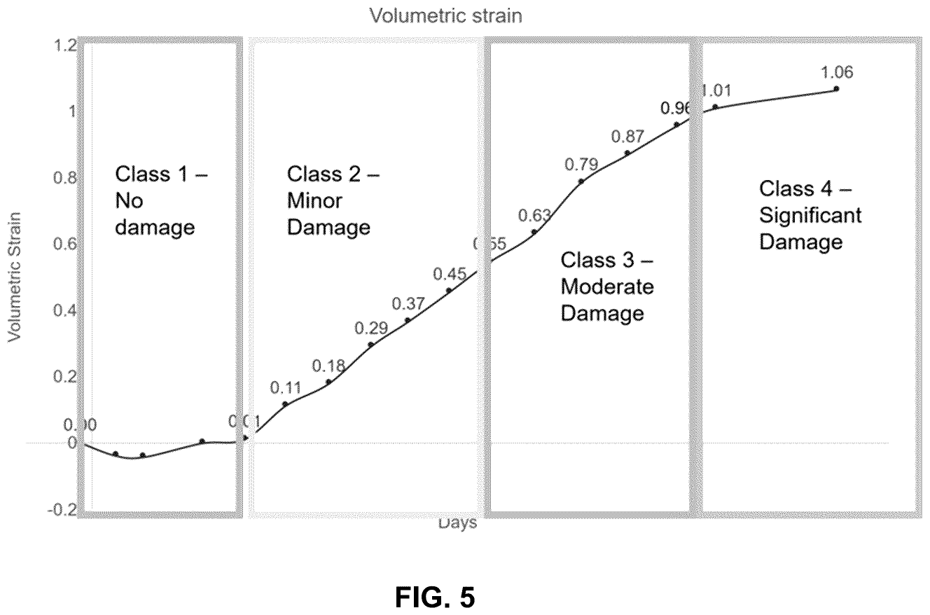

(3) Clusters were then validated by comparing them to the known strain/crack width data of the specimen. An example is shown below in FIG. 5 for the surrogate sample data. In FIG. 5, the volumetric strain is shown over time. The shaded boxes indicate each structural damage zone (as determined by the clusters). This corresponds well with what is known about how volumetric expansion relates to structural damage.

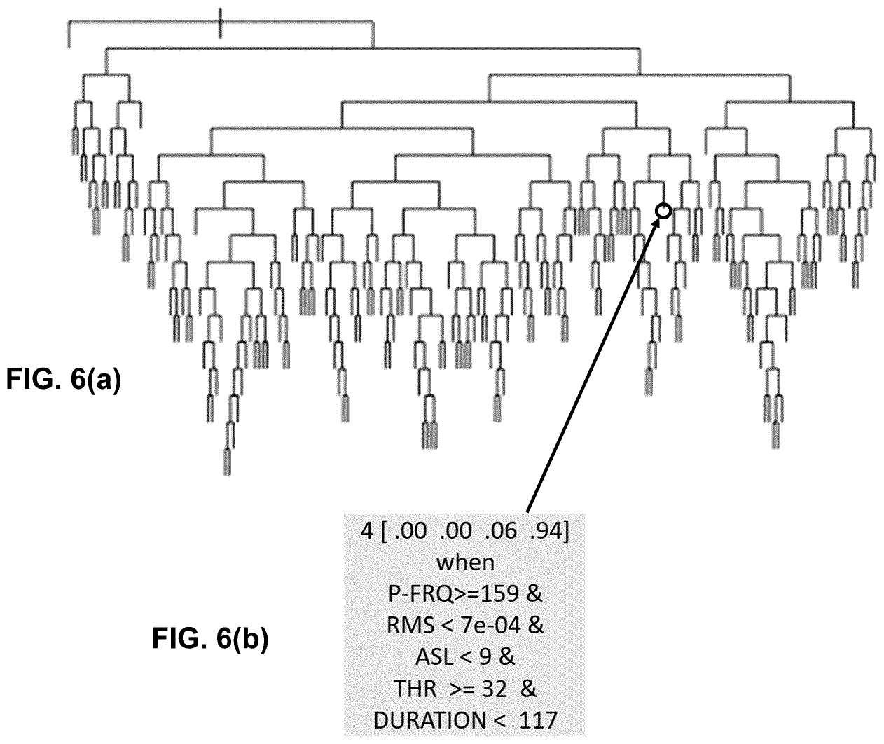

(4) A decision tree model was used to determine a set of rules that optimally fits the feature data to the 4 structural damage zones. This decision tree was trained using real-time data from just one channel. This addresses the two main challenges of this project and means that the resulting model does not rely on any historical data and can be used in situations where data from only one channel is available (it can also be used with data from multiple channels as well). The resulting tree structure is shown (without labels due to visualization limitations) in FIG. 6(a). An example of a collection of rules (extracted from decision nodes) resulting in a leaf node of class 4 (significant damage) is shown in FIG. 6(b). At this particular leaf node, there is a predicted 94% accuracy of the AE data coming from a structure with significant damage.

(5) Cross validation of the decision tree was performed on data that was held out of training (data that the model has not seen before) to determine accuracy. Data from all other channels from the surrogate specimen data were used as well as data from other surrogate specimens and the actual test specimen.

Results

The results from this pipeline using surrogate data yielded an overall accuracy of 92% (when averaged across all 10 channels) and individual channel accuracies ranging from 80-96%. This means that we expect the accuracies for given system with a single data channel to be within this range. We observed that the most classification error observed is that between zone 1 (no damage) and zone 2 (minor damage).

In addition, we have also looked at the model accuracy on another surrogate ASR model. In that model we observe accuracies of 75-89% for single channels. However, this is likely a skewed sample and does not necessarily accurately reflect the model's classification power. This surrogate specimen has data from just the first two structural damage zones (no and minor damage) and is therefore harder to classify due to the similarities between zones 1 and 2.

The last surrogate models that were utilized in this project were two in which corrosion was accelerated and measured. Using the model that was trained on the ASR data to classify its data into damage zones, we found that it was, overall, 67% accurate with a range of 42-87% per channel present in the corrosion specimens. We found that the surrogate specimen with a higher level of corrosion had higher accuracies for classification of damage zones.

We used the model to classify the data from the actual specimens that were aged in the testing chamber described above. Due to the low rate of aging, the ASR specimen's data only contained data from structural damage zone 1. The model was 97% accurate in predicting these as damage zone 1.

We have also investigated whether collecting data from a longer period of time and aggregating it provides an additional significant predictive power. We investigated aggregation of data ranging from 1 to 10 days in 1 day intervals. We found no significant increase in accuracy (at most +1.1% accuracy at a 2 day aggregation). Therefore, we have concluded that real-time analysis of signals is sufficient.

Final Product

The final deliverable is a Matlab script that implements each rule derived from the decision tree (example rule set seen in FIG. 6(b)) and classifies real-time AE data in to the four (4) structural damage zones. In addition, the script includes the capability to filter all features. This allows for the exclusion of data from noisy sensors that may bias the output of the algorithm.

Specific Accomplishments of this Subject Matter include:
Creation of an analysis pipeline to use to classify structural damage in concrete in real-time from just one AE sensor;
Conversion of model into a Matlab script for easy integration into existing systems; and
Inclusion of a set of user-defined filtering thresholds to allow for noise to be filtered out when system is implemented in the field.

Further development can center around continued accelerated aging of the specimens in the above-described controlled chamber; and comparisons between the developed data acquisition system and the laboratory scale systems.

The In light of time constraints, several similar surrogate specimens' data was used to complete the model. With more time, accelerated aging of the specimen in the controlled chamber could be continued to be able to collect data for all 4 structural damage zones to use for cross-validation of the model.

Further, differences in sensitivity, particularly sensitivity to noise ratio, may exist between the data acquisition system and the laboratory scale system. However, a robustly trained model would be expected to handle any such differences.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims.

What is claimed is:

1. A computing system, comprising:
one or more processors; and
one or more non-transitory computer-readable media that collectively store:
a machine-learned Artificial Intelligence (AI)-enabled technology neural network architecture model configured to receive Acoustic Emission (AE) data sensed from a structure and to predictively model Structural Health Maintenance (SHM) of the structure; and
instructions that, when executed by the one or more processors, configure the computing system to perform operations, the operations comprising:
obtaining detected AE data from sensors used with an associated structure to be monitored;
inputting the AE data into the machine-learned neural network architecture model;
determining at least two respective different damage zones associated with the monitored structure using decision tree-based rules; and
as an output of the machine-learned neural network architecture model, determining damage zone level predictions for the determined respective different damage zones of the associated monitored structure.

2. A computing system according to claim 1, wherein the one or more processors are further configured so that the determining operations include determining damage zone level predictions separately for each of a plurality greater than two of respective different damage zones of the associated monitored structure.

3. A computing system according to claim 1, wherein the one or more processors are further configured so that the machine-learned AI-enabled technology neural network architecture model learns to predict damage level of respective damage zones directly from raw AE data signals, for estimating in real-time the damage level of respective damage zones.

4. A computing system according to claim 1, wherein the one or more processors are further configured so that the machine-learned AI-enabled technology neural network architecture model predicts damage level separately for each of a plurality of respective different damage zones in either of concrete structures, composite material structures, and combinations of concrete and composite materials, using the information contained in the AE signal signatures.

5. A computing system according to claim 1, wherein the one or more processors are further configured so that the machine-learned AI-enabled technology neural network architecture model predicts damage level separately for each of four respective different damage zones in either of concrete structures, composite material structures, and combinations of concrete and composite materials, using the information contained in the AE signal signatures.

6. A computing system according to claim 1, wherein the monitored structure is equipped with a plurality of AE sensors configured for remote sensing.

7. A computing system according to claim 1, wherein the machine-learned AI-enabled technology neural network architecture model comprises a GoogLeNet convolutional neural network (CNN).

8. A computing system according to claim 1, wherein the one or more processors are further configured so that the acoustic emission signals are filtered using decision tree-based rules before being entered into an input layer of the convolutional neural network architecture.

9. A computer-implemented method, comprising:
obtaining, by a computing system comprising one or more computing devices, detected Acoustic Emission (AE) data from sensors used with an associated structure to be monitored;
inputting, by the computing system, the detected AE data into a machine-learned neural network architecture model configured to receive AE data sensed from a structure and to predictively model Structural Health Maintenance (SHM) of the structure and to determine at least two respective different damage zones associated with the monitored structure using decision tree-based rules; and
receiving, by the computing system, as an output of the machine-learned neural network architecture model, a determination by the computing system of damage zone level predictions for the determined respective different damage zones of the associated monitored structure.

10. A computer-implemented method according to claim 9, further comprises determining maintenance activities for the monitored structure based on determined damage zone level predictions for the determined respective different damage zones of the associated monitored structure.

11. A computer-implemented method according to claim 9, wherein the machine-learned neural network architecture model is trained using real-time data from at least one channel of data.

12. A computer-implemented method according to claim 9, wherein the machine-learned neural network architecture model is pre-trained using a relatively large number of images from a subset of images from a preexisting database of images.

13. A computer-implemented method according to claim 9, wherein the associated structure is continuously monitored in real-time, and the predictions for the determined respective different damage zones of the associated monitored structure are continuously produced in real-time.

14. A computer-implemented method according to claim 9, wherein the decision tree-based rules are determined as a set of rules that optimally fits the training data of the machine-learned neural network architecture model to four respective structural damage zones.
